(19) United States
(12) Patent Application Publication
(10) Pub. No.: US 2010/0118422 A1
(43) Pub. Date: May 13, 2010

(54) Concealed Tri-Fold Mirror With Hidden Storage Compartment And External Storage

(76) Inventor: Marie Holacka, West Palm Beach, FL (US)

Correspondence Address: JOHN C. SMITH, P.A., 4125 NW 58th LANE, BOCA RATON, FL, 33496, US

(21) Appl. No.: 12/269,947

(22) Filed: Nov. 13, 2008

(51) Int. Cl. G02B 5/08

(52) U.S. Cl. 359/854; 312/204

(57) ABSTRACT

A folding multipart mirror and storage device which is concealed within an ornamental cover. The folding multipart mirror has side mirror extensions that fold together to form a compact structure which minimizes space when not in use. When folded, the rear surface of the side mirror extensions can optionally be decorated with artwork such that when the mirror is not in use, the mirror assembly becomes a decorative work of art. Optionally, the side mirror extensions may also contain general storage compartments for a variety of items, or storage for jewelry. A hidden storage compartment for high-value items, such as jewelry, cash, legal documents, etc. is provided behind the central section of the mirror.

### BACKGROUND

1. Technical Field

This invention relates in general to a concealed mirror system. In particular, it relates to a compact tri-fold multipart mirror which is concealed within an ornamental box structure when not in use. In addition, the concealed mirror system also contains optional external storage compartments, as well as an optional hidden storage compartment for valuables.

2. Background of the Invention

As many people are aware, living quarters are often limited in size. As a result, trade-offs must often be made in terms of what can be placed and stored within the dwelling. Most dwellings incorporate at least one mirror to assist individuals when getting dressed. Unfortunately, while it is often useful to have a multipart mirror for dressing purposes, the space requirements for these mirrors in small living quarters precludes their use by many individuals. It would be desirable to have the ability to use a multipart mirror in a small space when needed, and regain the space when not needed.

In addition to the need for multipart mirrors, the size of most living quarters also places a premium on storage. Conventional mirrors provide nothing to the individual in terms of storage space. It would be desirable to take advantage of whatever space is dedicated to the mirror for simultaneous use as storage.

While general storage space is useful for a variety of goods, there are also goods of high-value, such as jewelry, which also need to be stored. However, their value and fragility generally argue against their storage in and among other items. It would be desirable to have a storage area for high-value and/or fragile items whose space could be shared with that used by a dressing mirror. Likewise, it would also be useful to have a place to hide valuables, such as jewelry, when they are not being used. While jewelry boxes are often used for this purpose, they're easy to find in the case of theft. It would be better to have a place to conceal valuables when not in use, rather than have them easily located. It would be desirable to have a method of using the same physical space to have a multipart mirror, to have storage for general goods, and to have hidden storage for valuable goods.

In addition to the foregoing, practical items such as mirrors and/or storage devices can often detract from the aesthetics in a room. It would be desirable to have a method of concealing mirrors and storage devices such that they provide an aesthetic appearance when not in use.

While the prior art has provided mirrors and storage devices, it has failed to provide a single device which provides a large multipart mirror that can be folded into a small space when not in use, which simultaneously provides storage space for general items, and which can provide concealed storage space for valuables, such as jewelry.

### SUMMARY OF THE INVENTION

This invention provides a tri-fold multipart mirror having a central mirror segment and opposing side mirrors which fold on top of one another when closed. In the closed position, the tri-fold multipart mirror forms a compact flat box structure which minimizes space. The rear surface of the side mirror which is exposed in the closed position has a variety of optional surface treatments which can include artwork, fabrics, leather or any other suitable aesthetic treatment, such that the tri-fold multipart mirror can function as artwork when in the closed position. The rear side of the outer side mirror can also be a mirror, so that it can be used a conventional single panel mirror when in the closed position. The exposed rear surface can optionally provide storage compartments such as pockets, netting, etc., or can provide retainer straps o hold small items such as photographs. An optional hidden storage compartment behind the central portion of the mirror provides safe storage for high-value items, such as jewelry, cash, legal documents, etc.

### BRIEF DESCRIPTION OF THE DRAWINGS

FIG. 1 is a front view of a preferred embodiment of the concealed tri-part mirror and storage unit in the closed position.

FIG. 2A is a front view of a preferred embodiment of the concealed tri-part mirror and storage unit in the open position.

FIG. 2B is a top view of a preferred embodiment of the concealed tri-part mirror and storage unit in the open position.

FIG. 2C is a top view of a preferred embodiment of the concealed tri-part mirror and storage unit in the open position.

FIG. 3A is a front view of a preferred embodiment of the concealed tri-part mirror and storage unit with door attachment brackets.

FIG. 3B is a side view of a preferred embodiment of the concealed tri-part mirror and storage unit with door attachment brackets.

FIG. 4 is a front view of a preferred embodiment of the concealed tri-part mirror and storage unit in the closed position with integral storage compartments in the side wings.

FIG. 5A is a top view of a preferred embodiment of the concealed tri-part mirror and storage unit in the closed position with storage compartments behind the mirror in the open position.

FIG. 5B is a top view of a preferred embodiment of the concealed tri-part mirror and storage unit in the open position with storage compartments hidden behind the mirror.

### DETAILED DESCRIPTION OF THE PREFERRED EMBODIMENT

Prior to a discussion of the figures, an overview of the invention will be presented. The invention provides individuals living in small quarters with the benefits of large multipart mirror to assist them when getting dressed or preparing for an outing. Likewise, the invention can also be effectively used in a commercial environment because, when not in use, the tri-fold mirror system can function as an artwork or as a storage unit for miscellaneous items.

In a first preferred embodiment, a tri-fold mirror system is provided in which there is a central mirror, and two hingedly attached side wings. In the closed position, the side wings are folded over the central mirror to minimize space. As a result, the tri-fold mirror provides the additional utility of a large tri-fold mirror when a mirror is needed, but takes a minimal amount of space when a mirror is not needed.

An important advantage provided by the invention is that due to its unique hinge structure, the side wing mirrors can be substantially the same size as the central mirror. The advantage provided by the large side wing mirrors is that the user will have much better side views than would be possible with smaller conventional side wings.

Installation can be accomplished in any suitable manner. For example, the tri-fold mirror can be secured to a wall, it can be a stand-alone unit, or provided with mounting brackets to secure it to a door or other object.

In a preferred embodiment of the invention, the rear surface of the side wing, that is exposed when the tri-fold mirror is in the closed position, is provided with artwork or other aesthetic treatment. It can be conventional artwork such as a painting, or other aesthetic treatments such as fabrics, leather covers, or other materials. Those skilled in the art will recognize that the type of aesthetic treatment, and the type of materials used, is only limited by a designer's imagination. As a result, when the tri-fold mirror is not in use it becomes a work of art to enhance the appearance of the room. In addition, the rear surface of the side wing can also have a mirror surface, so that it can be used as a conventional flat mirror when in the closed position.

In another embodiment, the rear surface of the side wing that is exposed when the tri-fold mirror is in the closed position can be optionally provided with storage capacity of various kinds. The rear surface can be fitted with pockets for holding small items, with elastic straps for holding things such as photographs, or even with shelving to hold or display various items. As a result, when the tri-fold mirror is not in use, it can provide a storage or display system for holding a variety of items or objects.

While the rear surfaces of the side wings can be used to hold or display a wide variety of items, there are some items that are preferably stored in a less accessible place. For example, small valuable items such as jewelry, cash, securities, legal documents, etc., are things that many individuals would prefer to store in a safe place that is less susceptible to theft. The invention addresses this issue by providing a hidden storage compartment behind a central portion of the mirror which conceals valuables.

Having discussed the invention in general, we turn now to a detailed discussion of the drawings.

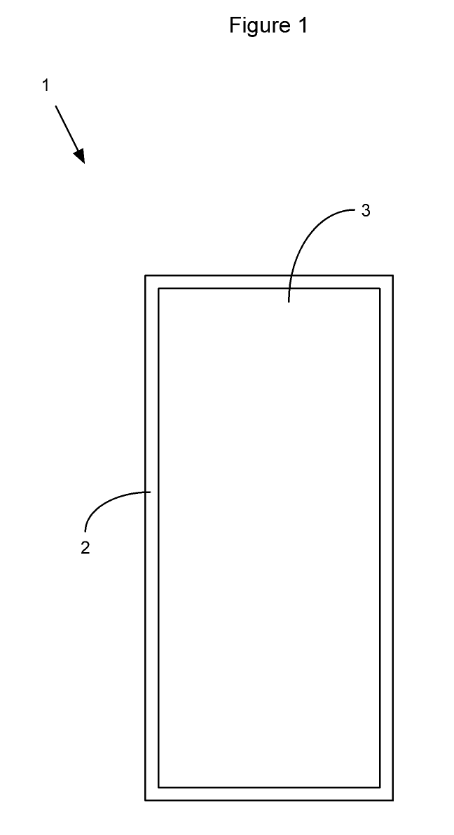

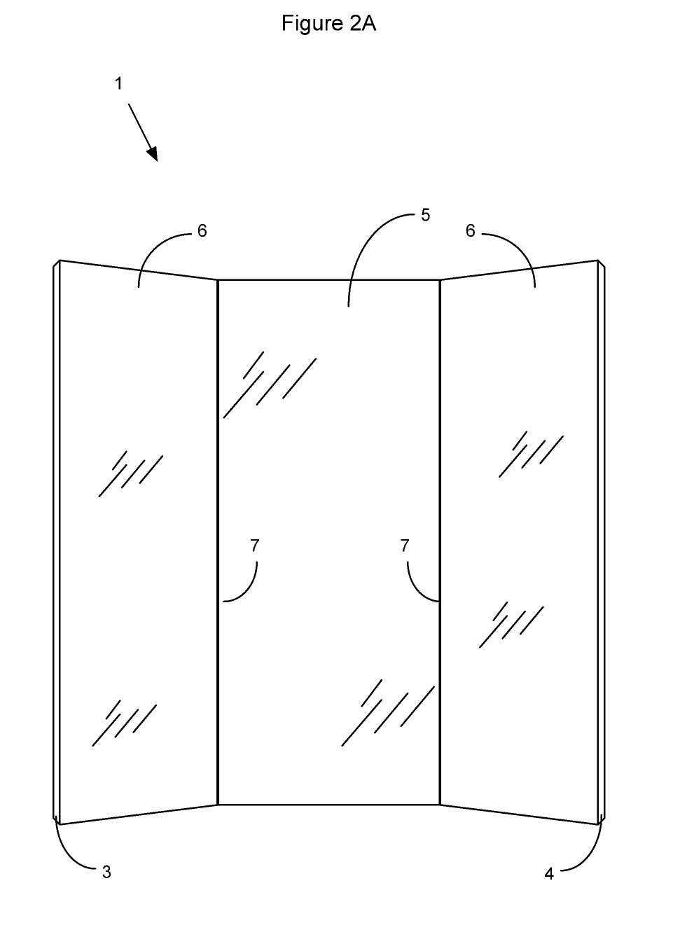

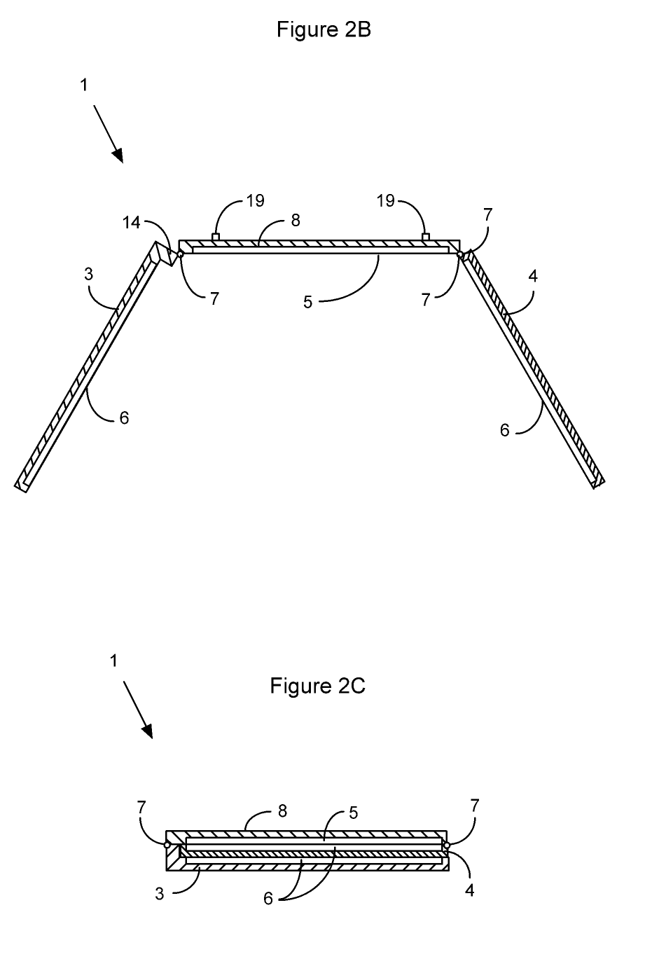

FIG. 1 is a front view of a preferred embodiment of the concealed mirror and storage unit 1 in the closed position. In the closed position, the inner side wing 4 (shown below in FIG. 2A) and outer side wing 3 are sized such that they overlap one another to form a single flat surface. In the closed position, only the rear side of the outer side wing 3 is visible. In the preferred embodiment, the side wings 3, 4 are substantially the same size as the central mirror 5 (shown below in FIG. 2A). As a result, the space required by the concealed mirror and storage unit 1 is minimized when it is not in use. Also shown is optional decorative frame (or border) 2. In the event that the outer side wing 3 has a surface such as artwork, the optional decorative frame 2 would serve the same function as a conventional frame.

In addition to providing decorative artwork, the outer side wing 3 can be adorned with any decorative treatment. For example, it can be covered with decorative fabric, leather, or like materials. It can be surfaced with any suitable material that will achieve a specific design goal. Those skilled in the art will recognize that the number and types of surface treatments can vary widely to suit any design choice. In this embodiment, the concealed mirror and storage unit 1 will act as a three-part folding mirror when in the open configuration, and double as artwork when in the closed configuration. Lastly, the outer side wing 3 can even be provided with a mirrored surface on its rear side. In this alternative embodiment, the concealed mirror and storage unit 1 will act as a three-part folding mirror when in the open configuration, and double as a conventional flat mirror when the closed configuration.

FIG. 2A is a front view of a preferred embodiment of the concealed mirror and storage unit 1 in the open position. As seen in this figure, the side wings 3, 4 fold outward at an adjustable angle. In this configuration, individuals can see themselves from several angles. Central mirror 5 is illustrated, as well as side mirrors 6 which are attached to inner and outer side wings 3, 4. The inner and outer side wings 3, 4 are attached via hinges 7. The advantage to the user, which is made possible by the hinge structure and corner extension, is that the larger inner and outer side wings 3, 4 are larger and thus provide a larger viewing area which would not otherwise be available.

FIG. 2B is a top view of a preferred embodiment of the concealed mirror and storage unit 1 in the open position. As shown, central mirror 5 is secured to central portion 8. Side wings 3, 4, which hold side mirrors 6, are also shown secured to central portion 8 via hinges 7. As noted above, the unique hinge arrangement used by the invention allows the use of inner and outer side wings 3, 4, and side mirrors 6 that are substantially the same size as the central mirror 5, while still allowing the inner and outer side wings 3, 4 to fold flat over one another. This is accomplished by corner extension 14 which extends the position of outer side wing 3 away from central portion 8 when in the folded position (shown in FIG. 2C). In turn, corner extension 14 is sized to provide sufficient space for inner side wing 4 to be laid flat against central portion 8.

This figure also illustrates optional wall mounts 19 which are used to secure the concealed mirror and storage unit 1 to a wall. Those skilled in the art will recognize that wall mounts 19 can be implemented by any suitable manner, such as screws, bracket, picture hangers, etc.

In the preferred embodiments, central portion 8 can be secured to a wall by any suitable means, such as hooks, screws, hangers, etc. Likewise, hooks can be used to hang the concealed mirror and storage unit 1 from a door or other structure. Further, the concealed mirror and storage unit 1 can be configured with a floor mounted stand to allow it to free stand at any desired location.

FIG. 2C is a top view of a preferred embodiment of the concealed mirror and storage unit 1 in the closed position. As can be seen, the corner extension 14 used by the invention allows the inner and outer side wings 3, 4 to fold flat over one another.

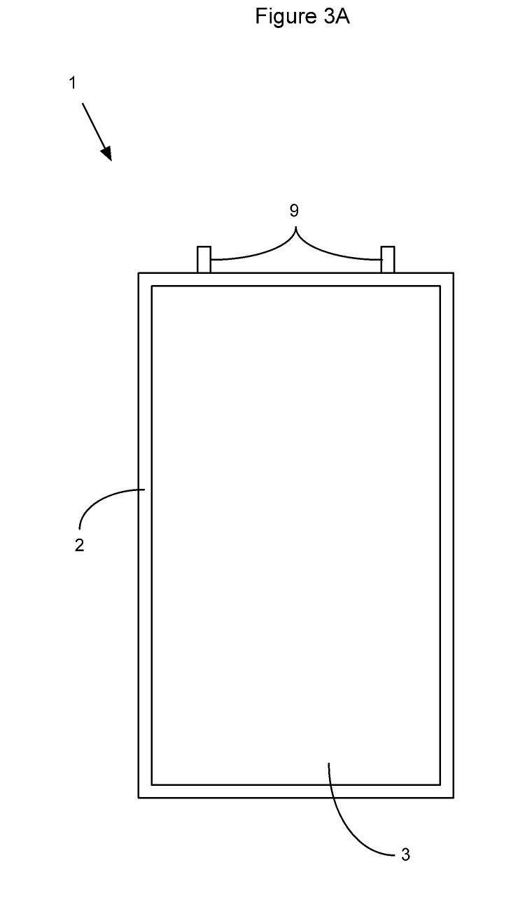

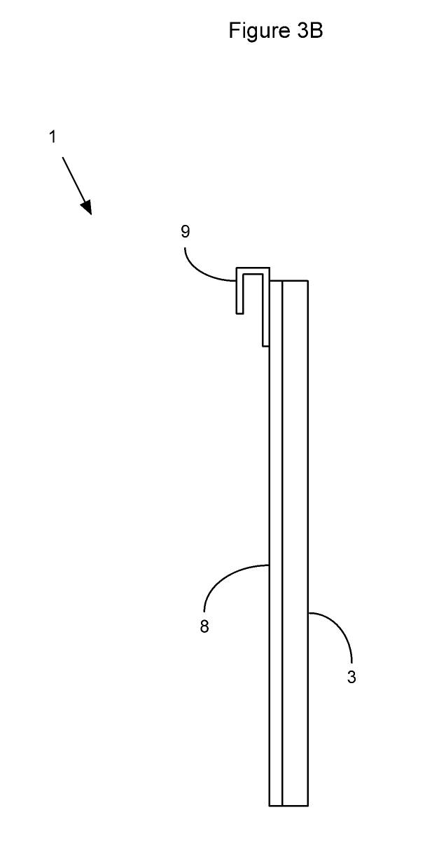

FIG. 3A is a front view of a preferred embodiment of the concealed mirror and storage unit 1 with door attachment brackets 9. This embodiment allows the concealed mirror and storage unit 1 could be moved to any convenient location and mounted on another structure, such as a door (not shown). This allows a concealed mirror and storage unit 1 to be used without permanently attaching it to a wall, and also to be stored when not needed. In this figure, the concealed mirror and storage unit 1 is illustrated in the closed configuration.

FIG. 3B is a side view of a preferred embodiment of the concealed mirror and storage unit 1 with door attachment brackets 9. The door attachment brackets 9 are secured to the surface of central portion 8 by any suitable means. Door attachment brackets 9 are sized such that they can fit over the top of a typical door (not shown). Placement of your attachment brackets 9 can vary so long as the concealed mirror and storage unit 1 can be placed in the desired location, and its placement will not interfere with opening or closing of the door.

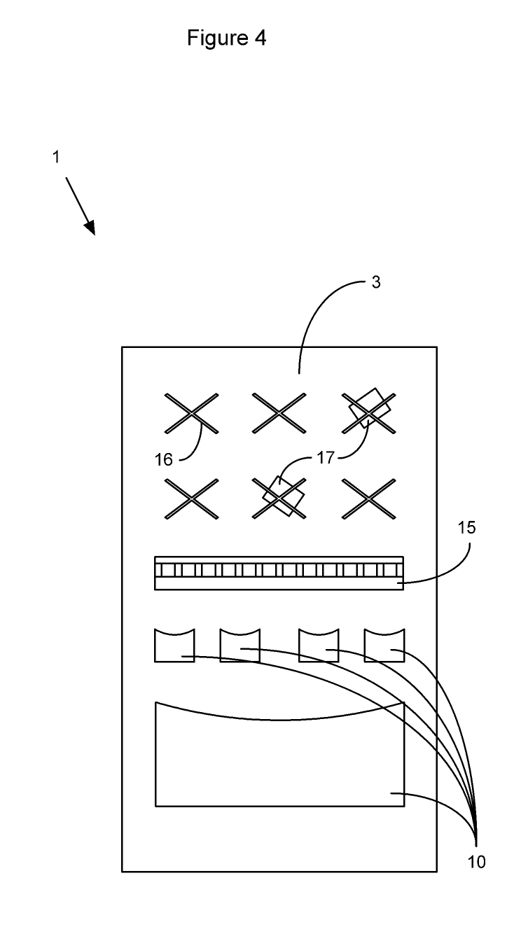

FIG. 4 is a front view of an alternative preferred embodiment of the concealed mirror and storage unit 1 in the closed position with a variety of integral storage devices. In this figure, optional decorative frame 2 has been omitted. By way of example, the following storage devices are shown to illustrate the possibilities for storage. One or more storage compartments 10, having a variety of sizes, can be mounted on the surface of outer side wing 3. Likewise, shelving 15 can be secured to outer side wing 3. Also shown in this figure are elastic straps 16 which can be used to hold paper documents 17, which may be photographs, business cards, etc. Of course, the number and type of storage devices attached to outer side wing 3 would vary by design choice. In this embodiment, a substantial amount of additional storage space is provided when the concealed mirror and storage unit 1 is in the closed configuration. This storage space can be used for any type of goods, for example, shoes.

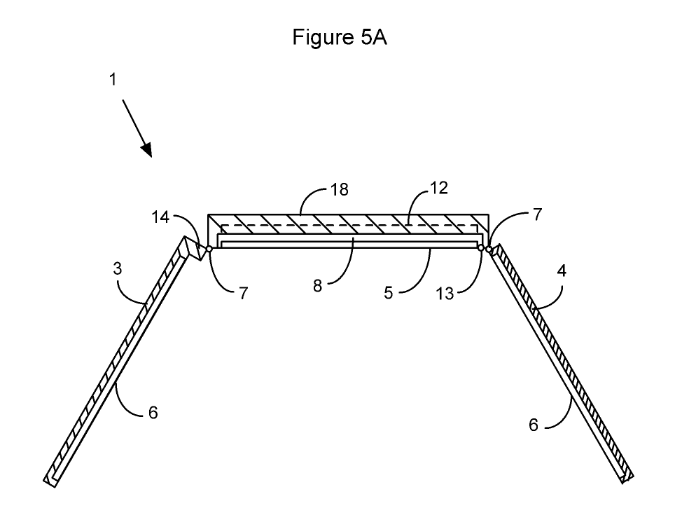

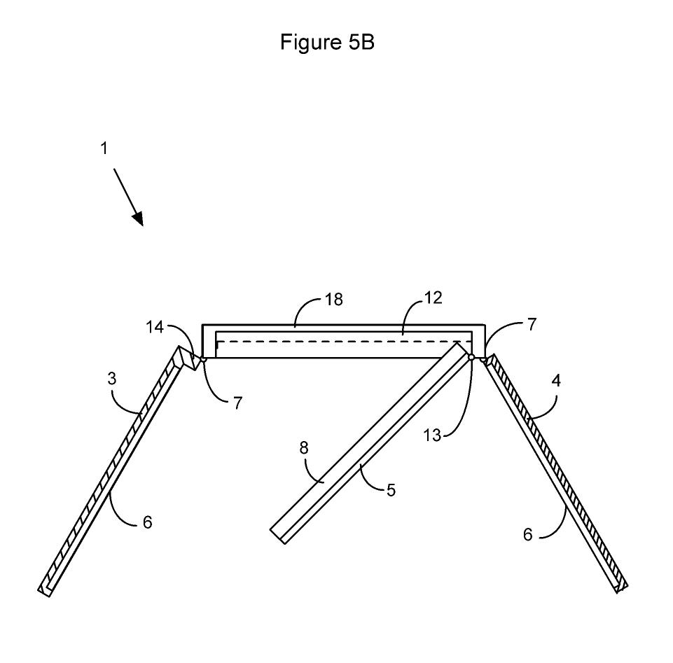

FIG. 5A is a top view of a preferred embodiment of the concealed mirror and storage unit 1 in the closed position with hidden storage compartment 12 behind the mirror. Storage compartment 12 is illustrated in dashed lines in this figure. The central mirror 5 is pivoted on hinge 13 to expose hidden storage compartment 12.

FIG. 5B is a top view of a preferred embodiment of the concealed mirror and storage unit 1 in the open position with storage compartment 12 exposed behind the central mirror 5. In the situation where an individual may want to hide valuables, such as jewelry or other items, this embodiment provides an individual with a hiding place that would be concealed from a thief.

While the hidden storage compartment is a useful feature, those skilled in the art will recognize that it is an option which may or may not be used. The folding tri-part mirror can be made with or without any storage capacity.

While specific embodiments have been discussed to illustrate the invention, it will be understood by those skilled in the art that variations in the embodiments can be made without departing from the spirit of the invention. For example, a surface treatment of side wings 3 can vary to suit any design goal, the size of the storage compartments can vary, the method of securing the device to a wall can vary, etc. Therefore, the invention shall be limited solely to the scope of the claims.

I claim:

1. A concealed mirror and storage device, comprising:
a central portion having a central mirror, the central mirror having a first side edge and a second side edge;
first and second side wings, the first and second side wings having substantially the same width as the central portion, and hingedly attached to the central portion such that they have an open configuration and a closed configuration; and
first and second side wing mirrors secured to the surface of the side wings, respectively, such that when in the open configuration, an individual can view both the central mirror and the first and second side wing mirrors such that the individual can see the individual's image from multiple angles; and
the first and second side wings further hingedly attached to the central portion such that when in the open position, they extend outward from the central portion at an angle, and when in the closed position, the first and second side wings fold over the central portion such that they are substantially parallel to the central portion;
whereby a multipart mirror can be stored in a minimal amount of space when not in use.

2. A device, as in claim 1, further comprising:
a corner extension extending from the first side edge of the central portion, the corner extension extending out from the central portion at least the thickness of the second side wing;
the second side wing is hingedly attached to the second side edge such that when in the closed position, it overlaps and is substantially parallel to the central portion; and
the first side wing is hingedly attached to the corner extension such that, when in the closed position, it overlaps and is substantially parallel to the second side wing.

3. A device, as in claim 2, further comprising:
a hidden storage compartment between the central portion and the central mirror; and
the central mirror hingedly attached to the central portion such that when in the closed position, the hidden storage compartment is hidden from view, and when in the open position, the hidden storage compartment is accessible.

4. A device, as in claim 3, wherein:
the first side wing, when in the closed position, has an outer surface with integral storage devices.

5. A device, as in claim 4, wherein:
the integral storage devices further comprise least one storage compartment.

6. A device, as in claim 4, wherein:
the integral storage devices further comprise least one shelf.

7. A device, as in claim 4, wherein:
the integral storage devices further comprise least one document strap.

8. A device, as in claim 3, wherein:
the first side wing, when in the closed position, has an outer surface with an aesthetic treatment.

9. A device, as in claim 8, wherein:
the aesthetic treatment is artwork.

10. A device, as in claim 8, wherein:
the aesthetic treatment is a mirror.

11. A device, as in claim 8, further comprising:
an ornamental frame extending around the periphery of the first side wing.

12. A device, as in claim 3, further comprising:
at least one door mount secured to the back of the central portion, the door mount sized to fit over the top of a door;
whereby, the device is removably attachable to a door.

13. A device, as in claim 3, further comprising:
at least one wall mount secured to the back of the central portion, the wall mount providing attachment means to attach the device to a wall;
whereby, the device is attachable to a wall.

14. A device, as in claim 2, wherein:
the first side wing, when in the closed position, has an outer surface with integral storage devices.

15. A device, as in claim 2, wherein:
the first side wing, when in the closed position, has an outer surface with an aesthetic treatment.

16. A device, as in claim 15, wherein:
the aesthetic treatment is artwork.

17. A device, as in claim 15, wherein:
the aesthetic treatment is a mirror.

18. A device, as in claim 15, further comprising:
an ornamental frame extending around the periphery of the first side wing.

19. A device, as in claim 2, further comprising:
at least one door mount secured to the back of the central portion, the door mount sized to fit over the top of a door;
whereby, the device is removably attachable to a door.

20. A device, as in claim 2, further comprising:
at least one wall mount secured to the back of the central portion, the wall mount providing attachment means to attach the device to a wall;
whereby, the device is attachable to a wall.
